(19) United States
(12) Patent Application Publication
(10) Pub. No.: US 2021/0271257 A1
(43) Pub. Date: Sep. 2, 2021

(54) INFORMATION PROCESSING DEVICE, OPTIMUM TIME ESTIMATION METHOD, SELF-POSITION ESTIMATION METHOD, AND RECORD MEDIUM RECORDING COMPUTER PROGRAM

(71) Applicant: SONY CORPORATION, TOKYO (JP)

(72) Inventor: RYO WATANABE, TOKYO (JP)

(21) Appl. No.: 17/250,296

(22) PCT Filed: May 27, 2019
(86) PCT No.: PCT/JP2019/020971

§ 371 Date: Dec. 29, 2020

(30) Foreign Application Priority Data
Jul. 6, 2018 (JP) 2018-129411

(51) Int. Cl. G05D 1/02; G06K 9/00; G06K 9/62; G01C 21/00

(52) U.S. Cl. CPC G05D 1/0231; G06K 9/00624; G05D 1/027; G01C 21/3833; G05D 1/0278; G06K 9/6267

(57) ABSTRACT

To improve the accuracy of self-position estimation, an information processing device (system) (100) includes a determination unit (117) configured to determine an acquisition time at which preliminary map production information for producing a preliminary map used by a mobile object to estimate a self-position is to be acquired based on time information related to a time at which a moving object exists in a predetermined region, the time information being based on external information of the predetermined region detected by an external sensor (112).

### FIELD

The present disclosure relates to an information processing device, an optimum time estimation method, a self-position estimation method, and a record medium recording a computer program.

### BACKGROUND

Recently, autonomous mobile objects equipped with artificial intelligence, such as a robot cleaner and a pet robot at home and a transport robot at a factory or a distribution warehouse, have been actively developed.

It is important for an autonomous mobile object to accurately estimate the current position and posture (hereinafter collectively referred to as self-position) of the own device not only to reliably arrive at a destination but also to securely behave in accordance with a surrounding environment.

Simultaneous localization and mapping (SLAM) is an exemplary technique of estimating the self-position. SLAM is a technique of simultaneously performing self-position estimation and environmental map production. The technique produces an environmental map by using information acquired by various sensors and simultaneously estimates the self-position by using the produced environmental map. In the self-position estimation using the environmental map, for example, comparison (map matching) is made between a broad-area map (hereinafter referred to as a preliminary map) produced in advance and a local environmental map produced from information acquired by a sensor in real time to specify a place at which both maps match each other, thereby estimating the self-position. The preliminary map is, for example, information in which the shapes of an environment such as an obstacle existing in a region is recorded as a two-dimensional map or a three-dimensional map, and the environmental map is, for example, information in which the shape of an environment such as an obstacle existing in surroundings of an autonomous mobile object is expressed as a two-dimensional map or a three-dimensional map.

### CITATION LIST

### Patent Literature

Patent Literature 1: Japanese Patent Application Laid-open No. 2016-177388

Patent Literature 2: Japanese Patent Application Laid-open No. 2015-215651

### SUMMARY

### Technical Problem

A preliminary map used in self-position estimation using an environmental map is produced, for example, as an autonomous mobile object acquires necessary information while moving in a target region. However, when the preliminary map is produced in a situation in which a large number of moving objects such as a person and an automobile exist, the accuracy of the preliminary map decreases, and accordingly, the accuracy of self-position estimation decreases.

Thus, the present disclosure discloses an information processing device, an optimum time estimation method, a self-position estimation method, and a record medium recording a computer program, which are capable of improving the accuracy of self-position estimation. Solution to Problem

In accordance with one aspect of the present disclosure, an information processing device comprises a determination unit configured to determine an acquisition time at which preliminary map production information for producing a preliminary map used by a mobile object to estimate a self-position is to be acquired based on time information related to a time at which a moving object exists in a predetermined region, the time information being based on external information of the predetermined region detected by an external sensor.

(Effects) With an information processing device according to an aspect of the present disclosure, it is possible to estimate a time optimum for acquiring information used in preliminary map production based on time information related to a time at which a moving object exists, and thus it is possible to produce a preliminary map that enables self-position estimation at higher accuracy. As a result, it is possible to achieve an information processing device, an optimum time estimation method, a self-position estimation method, and a record medium recording a computer program, which are capable of improving the accuracy of self-position estimation. Advantageous Effects of Invention

According to the present disclosure, it is possible to improve the accuracy of self-position estimation. Note that the effect described herein is not necessarily limited but may be any effect described in the present disclosure.

### BRIEF DESCRIPTION OF DRAWINGS

FIG. 1 is a block diagram illustrating an exemplary schematic configuration of an autonomous mobile object according to an embodiment of the present disclosure.

FIG. 2 is a block diagram illustrating an exemplary schematic configuration of a self-position estimation device (system) according to the embodiment of the present disclosure.

FIG. 3 is a diagram illustrating an exemplary self-position estimation system according to the embodiment of the present disclosure.

FIG. 4 is a block diagram illustrating a more detailed exemplary configuration of the self-position estimation device (system) according to the embodiment of the present disclosure.

FIG. 5 is a diagram illustrating an exemplary preliminary moving object information table according to the embodiment of the present disclosure.

FIG. 6 is a flowchart illustrating a schematic process of self-position estimation operation according to the embodiment of the present disclosure.

FIG. 7 is a flowchart illustrating exemplary operation at a preliminary map production optimum time estimation step according to the embodiment of the present disclosure.

FIG. 8 is a flowchart illustrating exemplary optimum time estimation processing according to the embodiment of the present disclosure.

FIG. 9 is a flowchart illustrating exemplary operation at a self-position estimation preliminary map production step according to the embodiment of the present disclosure.

FIG. 10 is a flowchart illustrating exemplary operation at a self-position estimation step according to the embodiment of the present disclosure.

FIG. 11 is a block diagram illustrating a detailed exemplary configuration of a self-position estimation device (system) according to a modification of the embodiment of the present disclosure.

### DESCRIPTION OF EMBODIMENTS

An embodiment of the present disclosure will be described below in detail with reference to the accompanying drawings. Note that, in the embodiment described below, identical sites are denoted by an identical reference sign to omit duplicate description thereof.

The present disclosure will be described in accordance with the following order of contents.

1. Embodiment

1.1 Autonomous mobile object

1.2 Self-position estimation device (system)

1.2.1 SLAM and map matching

1.2.2 Exemplary schematic configuration of self-position estimation device (system)

1.2.3 Detailed exemplary configuration of self-position estimation device (system)

1.3 Self-position estimation operation

1.3.1 Schematic process of self-position estimation operation

1.3.2 Preliminary map production optimum time estimation step

1.3.2.1 Optimum time estimation processing

1.3.3 Self-position estimation preliminary map production step

1.3.4 Self-position estimation step

1.4 Effects

1.5 Modification

### 1. Embodiment

An information processing device, an optimum time estimation method, a self-position estimation method, and a record medium recording a computer program according to the embodiment of the present disclosure will be described below in detail with reference to the accompanying drawings. In the present embodiment, a time point or time slot (hereinafter referred to as an optimum time) that is optimum for production of a preliminary map is estimated, and preliminary map production information is acquired at the estimated optimum time to produce a preliminary map with which the accuracy of self-position estimation can be improved.

1.1 Autonomous Mobile Object

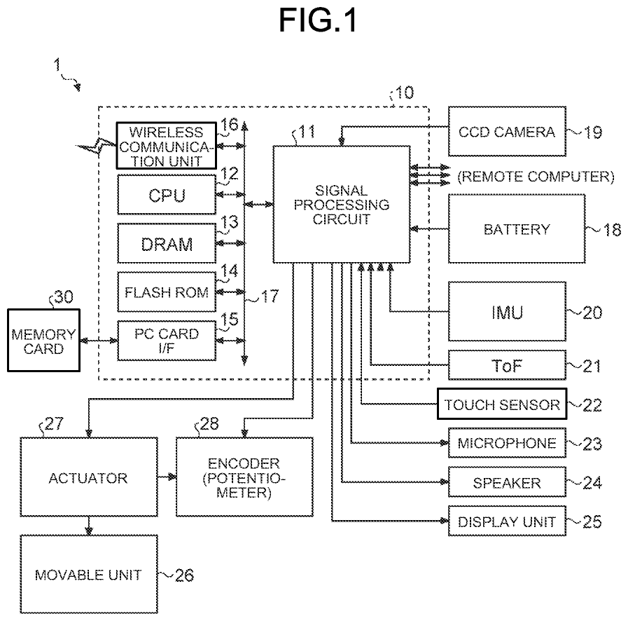

FIG. 1 is a block diagram illustrating an exemplary schematic configuration of an autonomous mobile object according to the present embodiment. As illustrated in FIG. 1, this autonomous mobile object 1 includes, for example, a control unit 10 formed by connecting a central processing unit (CPU) 12, a dynamic random access memory (DRAM) 13, a flash read only memory (ROM) 14, a personal computer (PC) card interface (I/F) 15, a wireless communication unit 16, a signal processing circuit 11 with one another through an internal bus 17, and a battery 18 as a power source of the autonomous mobile object 1.

The autonomous mobile object 1 also includes, as operation mechanisms for achieving operations such as movement and gesture, a movable unit 26 including joint parts of arms and legs, wheels, and caterpillars, and an actuator 27 for driving the movable unit.

In addition, the autonomous mobile object 1 includes, as sensors (hereinafter referred to as internal sensors) for acquiring information such as a movement distance, a movement speed, a movement direction, and a posture, an inertial measurement unit (IMU) 20 for detecting the orientation and motion acceleration of the own device, and an encoder (potentiometer) 28 configured to detect the drive amount of the actuator 27. Note that, in addition to these components, an acceleration sensor, an angular velocity sensor, and the like, may be used as the internal sensors.

In addition, the autonomous mobile object 1 includes, as sensors (hereinafter referred to as external sensors) configured to acquire information such as a land shape in surroundings of the own device and the distance and direction to an object existing in surroundings of the own device, a charge coupled device (CCD) camera 19 configured to capture an image of an external situation, and a time-of-flight (ToF) sensor 21 configured to measure the distance to an object existing in a particular direction with respect to the own device. Note that, in addition to these components, for example, a light detection-and-ranging or laser-imaging-detection-and-ranging (LIDAR) sensor, a global positioning system (GPS) sensor, a magnetic sensor, and a measurement unit (hereinafter referred to as a radio field intensity sensor) for the radio field intensity of Bluetooth (registered trademark), Wi-Fi (registered trademark), or the like at the wireless communication unit 16 may be used as the external sensors.

Note that the autonomous mobile object 1 may be provided with a touch sensor 22 for detecting physical pressure received from the outside, a microphone 23 for collecting external sound, a speaker 24 for outputting voice or the like to surroundings, and a display unit 25 for displaying various kinds of information to a user or the like.

In the above-described configuration, various sensors such as the IMU 20, the touch sensor 22, the ToF sensor 21, the microphone 23, the speaker 24, and the encoder (potentiometer) 28, the display unit, the actuator 27, the CCD camera (hereinafter simply referred to as camera) 19, and the battery 18 are each connected with the signal processing circuit 11 of the control unit 10.

The signal processing circuit 14 sequentially acquires sensor data, image data, and voice data supplied from various sensors described above and sequentially stores each data at a predetermined position in the DRAM 13 through the internal bus 17. In addition, the signal processing circuit 11 sequentially acquires battery remaining amount data indicating a battery remaining amount supplied from the battery 18 and stores the data at a predetermined position in the DRAM 13.

The sensor data, the image data, the voice data, and the battery remaining amount data stored in the DRAM 13 in this manner are used when the CPU 12 performs operation control of the autonomous mobile object 1, and are transmitted to an external server or the like, through the wireless communication unit 16 as necessary. Note that the wireless communication unit 16 may be a communication unit for performing communication with an external server or the like, through, for example, Bluetooth (registered trademark) or Wi-Fi (registered trademark) as well as a predetermined network such as a wireless local area network (LAN) or a mobile communication network.

For example, in an initial phase in which the autonomous mobile object 1 is turned on, the CPU 12 reads, through the PC card interface 15 or directly, a control program stored in a memory card 30 or the flash ROM 14 mounted on a PC card slot (not illustrated) and stores the program in the DRAM 13.

In addition, the CPU 12 determines the situation of the own device and the surroundings, the existence of an instruction or action from the user, and the like, based on the sensor data, the image data, the voice data, and the battery remaining amount data sequentially stored in the DRAM 13 by the signal processing circuit 11 as described above.

In addition, the CPU 12 executes self-position estimation and various kinds of operation by using map data stored in the DRAM 13 or the like, or map data acquired from an external server or the like, through the wireless communication unit 16, and various kinds of information.

Then, the CPU 12 determines subsequent behavior based on a result of the above-described determination, an estimated self-position, the control program stored in the DRAM 13, and the like, and executes various kinds of behavior such as movement and gesture by driving the actuator 27 needed based on a result of the determination.

In this process, the CPU 12 generates voice data as necessary, provides the data as a voice signal to the speaker 24 through the signal processing circuit 11 to externally output voice based on the voice signal, and causes the display unit 25 to display various kinds of information.

In this manner, the autonomous mobile object 1 is configured to autonomously behave in accordance with the situation of the own device and surroundings and an instruction and an action from the user.

Note that the above-described configuration of the autonomous mobile object 1 is merely exemplary and applicable to various kinds of autonomous mobile objects in accordance with a purpose and usage. Specifically, the autonomous mobile object 1 in the present disclosure is applicable not only to an autonomous mobile robot such as a domestic pet robot, a robot cleaner, an unmanned aircraft, a follow-up transport robot, and the like, but also to various kinds of mobile objects, such as an automobile, configured to estimate the self-position.

1.2 Self-Position Estimation Device (System)

Subsequently, a self-position estimation device (system) configured to estimate the self-position of the autonomous mobile object 1 will be described below in detail with reference to the accompanying drawings.

1.2.1 SLAM and Map Matching

As described above, SLAM is available as a technique of self-position estimation, for example. One of technologies for achieving SLAM is map matching. The map matching is, for example, a technique of specifying matching feature points and non-matching feature points between different pieces of map data and is used in moving object detection, map connection, self-position estimation (also referred to as map search), and the like, when SLAM is performed.

For example, in the moving object detection, matching feature points and non-matching feature points are specified through comparison (map matching) of two or more pieces of map data produced by using pieces of information acquired by a sensor at different time points, thereby identifying stationary objects (such as a wall and a sign) and moving objects (such as a person and a chair) included in the map data.

In the map connection, the map matching is used when a set of pieces of small-volume map data (for example, environmental maps) are positioned and connected to produce large-volume map data (for example, a preliminary map).

In the self-position estimation (map search), as described above, comparison (map matching) is made between a preliminary map produced in advance and an environmental map produced in real time to specify a place at which both maps match each other, thereby performing self-position estimation.

In SLAM using such map matching, it is important to prepare a preliminary map having a high information density in self-position estimation, in particular, so that the accuracy of the estimation is improved. Note that having a high information density is, for example, having a large number of stationary objects (or feature points) included in the unit area.

A preliminary map used in self-position estimation is, for example, an occupied lattice map or image feature point information produced by using information (hereinafter referred to as external information) acquired by an external sensor such as a camera, a ToF sensor, or a LIDAR sensor, configured to detect the surrounding environment. Thus, when external information used in preliminary map production includes a moving object such as a person, a pet, or a chair, the preliminary map production using the external information produces a preliminary map in which a moving object that has already moved is included as a stationary object, which decreases the accuracy of self-position estimation by the map matching. Note that, in the following description, information related to the own device and acquired by an internal sensor is referred to as internal information in comparison to external information acquired by an external sensor.

A method of removing information of a moving object from external information acquired for preliminary map production is thought as a method of avoiding inclusion of the moving object as a stationary object in a preliminary map. In this method, for example, when the external information is a still image acquired by a camera, a region occupied by the moving object in the still image is removed through mask processing or the like. However, with this method, the amount of information used for preliminary map production is reduced, and accordingly, the information density of the preliminary map decreases, which potentially makes it difficult to perform self-position estimation at high accuracy. Thus, the present embodiment describes, with reference to examples, an information processing device, an information processing system, an optimum time estimation method, a self-position estimation method, and a computer program that enable self-position estimation at high accuracy by reducing decrease of the information density of a preliminary map.

1.2.2 Exemplary Schematic Configuration of Self-Position Estimation Device (System)

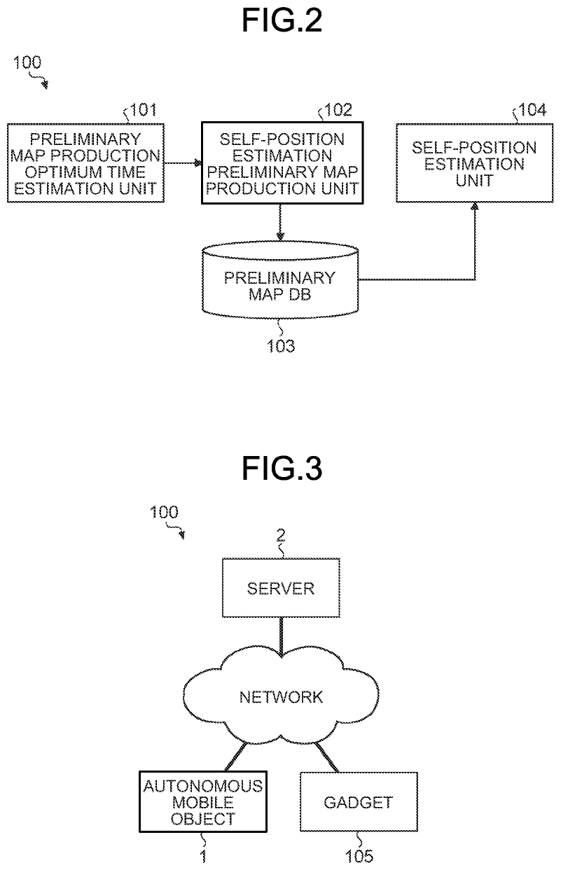

FIG. 2 is a block diagram illustrating an exemplary schematic configuration of the self-position estimation device (system) according to the present embodiment. As illustrated in FIG. 2, this self-position estimation device (system) 100 includes a preliminary map production optimum time estimation unit 101, a self-position estimation preliminary map production unit 102, a preliminary map database (map storage unit) 103, and a self-position estimation unit (determination unit) 104.

The preliminary map production optimum time estimation unit 101 estimates and determines a time optimum for acquiring information used in preliminary map production for a particular region in which the autonomous mobile object 1 operates. Specifically, the preliminary map production optimum time estimation unit 101 estimates, as the time optimum for acquiring information used in preliminary map production, a time slot in which the ratio of moving object information in external information acquired by using an external sensor mounted on the autonomous mobile object 1 is estimated to be smallest, and determines the time as a time at which information used in preliminary map production is to be acquired. For example, the preliminary map production optimum time estimation unit 101 estimates and determines, as the time optimum for acquiring information used in preliminary map production, a time slot in which the ratio of a region of a moving object in an image acquired by a camera (for example, the camera 19 in FIG. 1) as an external sensor is estimated to be smallest. Alternatively, the preliminary map production optimum time estimation unit 101 estimates and determines, as the time optimum for acquiring information used in preliminary map production, a time slot in which the number of moving objects included in an image acquired by a camera (for example, the camera 19 in FIG. 1) is estimated to be smallest.

The self-position estimation preliminary map production unit 102 acquires, at the optimum time estimated by the preliminary map production optimum time estimation unit 101, information related to the region in which the autonomous mobile object 1 operates, and produces a preliminary map by using the acquired information. In addition, the self-position estimation preliminary map production unit 102 stores data of the produced preliminary map in the preliminary map database 103.

The self-position estimation unit 104 executes estimation of the self-position of the autonomous mobile object 1 by using the preliminary map acquired from the preliminary map database 103. For example, the self-position estimation unit 104 acquires, from the preliminary map database 103, a preliminary map of a region to which the autonomous mobile object 1 currently belongs and surroundings of the autonomous mobile object 1, and estimates the self-position of the autonomous mobile object 1 by using the acquired preliminary map and information acquired by sensors in real time. For example, the self-position estimation unit 104 compares the acquired preliminary map and a local environmental map produced from information acquired from sensors in real time and performs specification (map matching) of a place at which both maps match each other, thereby estimating the self-position of the autonomous mobile object 1.

Note that the self-position estimation device (system) 100 illustrated in FIG. 2 may be achieved only by the autonomous mobile object 1 or may be achieved by a system (including a cloud computing system) in which the autonomous mobile object 1 and a server 2 are connected with each other through a predetermined network 3 such as the Internet, a LAN, or a mobile communication network as illustrated in FIG. 3.

1.2.3 Detailed Exemplary Configuration of Self-Position Estimation Device (System)

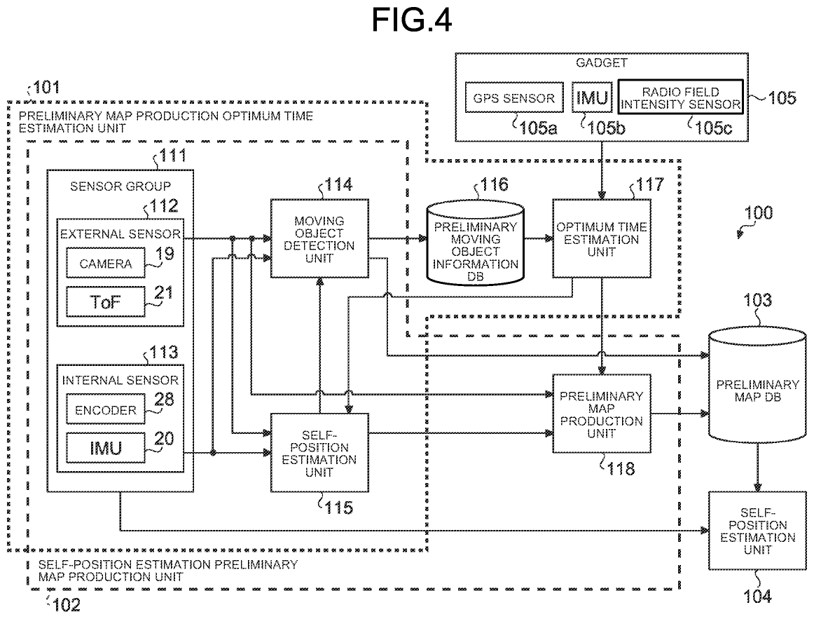

Subsequently, a more detailed exemplary configuration of the self-position estimation device (system) 100 according to the present embodiment will be described below in detail with reference to the accompanying drawings. FIG. 4 is a block diagram illustrating a more detailed exemplary configuration of the self-position estimation device (system) according to the present embodiment and is a block diagram focused on the configurations of the preliminary map production optimum time estimation unit 101 and the self-position estimation preliminary map production unit 102, in particular.

As illustrated in FIG. 4, the preliminary map production optimum time estimation unit 101 and the self-position estimation preliminary map production unit 102 in the self-position estimation device (system) 100 are constituted by a sensor group 111 including an external sensor 112 and an internal sensor 113, a moving object detection unit (detection unit, generation unit) 114, a self-position estimation unit 115, a preliminary moving object information database (moving object information storage unit) 116, an optimum time estimation unit 117, and a preliminary map production unit 118. Among these components, for example, the sensor group 111, the moving object detection unit 114, the self-position estimation unit 115, the preliminary moving object information database 116, and the optimum time estimation unit 117 are included in the preliminary map production optimum time estimation unit 101. For example, the sensor group 111, the moving object detection unit 114, the self-position estimation unit 115, and the preliminary map production unit 118 are included in the self-position estimation preliminary map production unit 102.

The external sensor 112 in the sensor group 111 is a sensor for acquiring information of the surrounding environment of the autonomous mobile object 1. The LIDAR sensor, the GPS sensor, the magnetic sensor, the radio field intensity sensor, and the like, may be used as the external sensor 112 in addition to the camera 19 and the ToF sensor 21. For example, when the camera 19 is used as the external sensor 112, information of surroundings of the autonomous mobile object 1 is acquired as image data (any of a still image and a moving image). When the ToF sensor 21 is used as the external sensor 112, information related to the distance and direction to an object existing in surroundings of the autonomous mobile object 1 is acquired.

The internal sensor 113 is a sensor for acquiring information related to the orientation, motion, posture, and the like of the autonomous mobile object 1. For example, an acceleration sensor and a gyro sensor may be used as the internal sensor 113 in addition to the encoder (potentiometer) 28 of a wheel or a joint, the IMU 20, and the like.

The self-position estimation unit 115 estimates the current position and posture (self-position) of the autonomous mobile object 1 by using external information input from the external sensor 112 and/or internal information input from the internal sensor 113. In the present embodiment, a dead-reckoning scheme and a star-reckoning scheme are exemplarily described as a method (hereinafter simply referred to as a self-position estimation method) of estimating the self-position of the autonomous mobile object 1. Note that the self-position estimation unit 115 may have a configuration identical to or separately independent from that of the self-position estimation unit 104.

The self-position estimation method of the dead-reckoning scheme is a method of estimating the self-position of the autonomous mobile object 1 through motion dynamics calculation by using internal information input from the internal sensor 113 such as the encoder 28, the IMU 20, an acceleration sensor, or a gyro sensor. The self-position estimation method of the dead-reckoning scheme includes an odometry calculation method of performing forward dynamics calculation based on the value of the encoder 28 attached to each joint of the autonomous mobile object 1 and information of the geometric shape of the autonomous mobile object 1. Physical quantities acquirable as internal information include speed, acceleration, relative position, and angular velocity. In the self-position estimation of the dead-reckoning scheme, these physical quantities are multiplied to calculate absolute position and posture necessary for self-position estimation. The self-position estimation of the dead-reckoning scheme has an advantage that self-position information can be continuously calculated in a high-rate constant period without discontinuity as compared to the external sensor 112. However, in the self-position estimation of the dead-reckoning scheme, integration processing is performed to estimate absolute position and posture, which leads to a disadvantage that accumulated error is generated in long-time measurement.

The self-position estimation method of the star-reckoning scheme is a method of estimating the self-position of the autonomous mobile object 1 through map matching or geometric shape matching by using external information input from the external sensor 112 such as the camera 19, the ToF sensor 21, the GPS sensor, the magnetic sensor, or the radio field intensity sensor. Physical quantities acquirable as external information include position and posture. The self-position estimation of the star-reckoning scheme has an advantage that absolute position and posture can be directly calculated from a physical quantity acquired each time. Thus, for example, accumulated error in position and posture through the self-position estimation of the dead-reckoning scheme can be corrected with the self-position estimation of the star-reckoning scheme. However, the self-position estimation of the star-reckoning scheme has a disadvantage that the self-position estimation of the star-reckoning scheme cannot be used for a place and a situation where a preliminary map, radio field intensity information, and the like cannot be acquired, and a disadvantage that calculation cost is high because large-volume data such as images and point cloud data needs to be processed.

Thus, in the present embodiment, the self-position estimation of the dead-reckoning scheme and the self-position estimation of the star-reckoning scheme are combined to enable self-position estimation at higher accuracy. Specifically, the self-position estimation unit 104 corrects a self-position estimated through the self-position estimation of the dead-reckoning scheme with a self-position estimated through the self-position estimation of the star-reckoning scheme. Note that, as for the self-position estimation unit 115, since it is impossible to perform the self-position estimation of the star-reckoning scheme when a preliminary map is yet to be produced, the self-position estimation of the dead-reckoning scheme and the self-position estimation of the star-reckoning scheme may be combined as appropriate when possible.

The moving object detection unit 114 detects a moving object existing in surroundings of the autonomous mobile object 1 based on information acquired by the external sensor 112 such as the camera 19 or the ToF sensor 21. For example, moving object detection using optical flow, grid map, or the like, may be applied as a method of moving object detection by the moving object detection unit 114 in place of moving object detection by map matching as described above. The moving object detection unit 114 specifies a time point at which a moving object is detected by, for example, referring to an internal clock mounted in the autonomous mobile object 1. In addition, the moving object detection unit 114 receives, from the self-position estimation unit 115, information of a position or region where the autonomous mobile object 1 exists when the above-described moving object is detected. Then, the moving object detection unit 114 stores, in the preliminary moving object information database 116, information (hereinafter referred to as preliminary moving object information) related to the moving object and acquired as described above. Note that items in the preliminary moving object information detected by the moving object detection unit 114 will be introduced in description of the preliminary moving object information database 116. Examples of moving objects to be detected in the present embodiment include various kinds of moving objects expected to be moved in everyday life, namely, animals such as a person and a pet, movable furniture and office equipment such as a chair and a potted plant, traveling bodies such as an automobile or a bicycle.

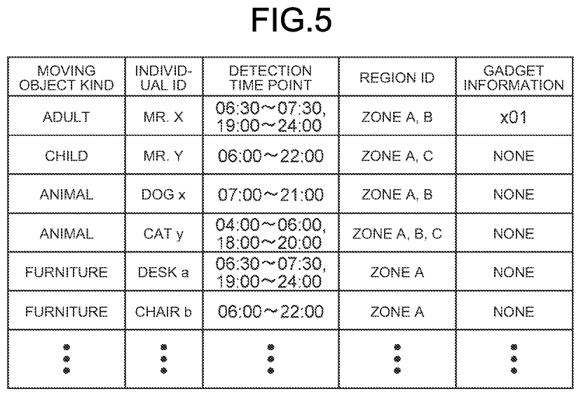

The preliminary moving object information database 116 receives the preliminary moving object information from the moving object detection unit 114 and stores the preliminary moving object information. The preliminary moving object information is stored in the preliminary moving object information database 116, for example, as data in a table format. FIG. 5 illustrates an exemplary preliminary moving object information table. As illustrated in FIG. 5, the preliminary moving object information registered in the preliminary moving object information table has the items of moving object kind ID, individual ID, detection time point, region ID, and gadget information.

The moving object kind ID is information for identifying the kind of a moving object such as a person, an animal (such as cat or dog), or movable furniture (such as chair or potted plant). The moving object kind ID may be generated through, for example, execution of recognition processing such as feature point extraction or pattern matching on external information by the moving object detection unit 114.

The individual ID is information for identifying an individual of the moving object and is, for example, information for identifying an individual person when the moving object is a person. The moving object kind ID may be generated through, for example, execution of recognition processing such as feature point extraction processing or pattern matching processing on external information based on information learned by the moving object detection unit 114 in the past, information registered in a moving object information table by the user in advance, or the like.

The detection time point is time information related to a time (time point or time slot) at which the moving object exists in a target region, and is information related to a time point or time slot at which the moving object is detected. The detection time point may be generated through, for example, specification of, by the moving object detection unit 114, a time point at which external information is acquired by the external sensor 112 or a time point at which external information is input from the external sensor 112.

The region ID is information specifying a position or region where the moving object is detected, or a position or region where the autonomous mobile object 1 exists when the moving object is detected. The region ID may be, for example, information for specifying a position or region, which is input from the self-position estimation unit 115 when the moving object is detected by the moving object detection unit 114.

The gadget information is information related to whether a gadget is registered for the moving object when individual identification (individual ID specification) of the moving object is successful, and is identification information of the gadget in a case in which the gadget is registered. The gadget information may be, for example, information directly or indirectly registered in the preliminary moving object information table by the administrator of the autonomous mobile object 1, the owner or administrator of the gadget, or the like. Note that a gadget 105 in the present embodiment may be a wearable terminal such as a cellular phone (including a smartphone), a smart watch, a portable game machine, a portable music player, a digital camera, or a laptop personal computer (PC) and may be a communication terminal on which external sensors configured to enable current position specification, such as a GPS sensor 105a, an IMU 105b, and a radio field intensity sensor 105c, are mounted. The information registered in the preliminary moving object information table may be manually added, changed, and deleted through a predetermined communication terminal such as the gadget 105.

Description continues with reference to FIG. 4. The optimum time estimation unit 117 estimates, based on the preliminary moving object information registered in the preliminary moving object information database 116, a time slot in which the ratio of moving object information in external information acquired by using the external sensor 112 is estimated to be smallest. For example, the optimum time estimation unit 117 specifies, for each time slot, the number of moving objects existing in a target region and estimates, as an optimum time for the target region, a time slot in which the number of moving objects is smallest based on the specified number. The optimum time may be estimated by performing weighting in accordance with a moving object size specified based on the moving object kind ID, the individual ID, or the like. For example, when a weight for a person is 10 and a weight for a pet having a size smaller than that of a person is 3, a score is calculated by summing, for each time slot, a value obtained by multiplying the number of detected persons by 10 and a value obtained by multiplying the number of detected pets by 3, and a time slot having a smallest score may be estimated as the optimum time. Accordingly, a time slot in which the ratio of a region of a moving object in an image acquired by the camera 19 is estimated to be smallest can be estimated as the time optimum for acquiring information used in preliminary map production.

In the optimum time estimation by the optimum time estimation unit 117, information acquired by an external sensor (such as the GPS sensor 105a, the IMU 105b, or the radio field intensity sensor 105c) mounted on the gadget 105 owned by a person may be utilized. For example, when, in the preliminary moving object information table, a gadget is registered for a moving object (mainly, a person) for which individual identification is performed based on the individual ID, the optimum time may be estimated by using information (for example, information related to an existence time slot) specified by the external sensor of the gadget 105 in priority to information of the detection time point and the region ID associated with the moving object. Alternatively, when preliminary map production is to be executed at the optimum time estimated by using the information registered in the preliminary moving object information table, whether the processing execution is permitted may be determined based on information (for example, existence information) obtained by the external sensor of the gadget 105 in real time. In this case, for example, it is possible to determine that preliminary map production is not to be executed when a person who would usually go out is present.

The optimum time estimated by the optimum time estimation unit 117 may be changed depending on the kind of an external sensor in use, a target region, a weather condition (or forecast), a day of week, or the like. For example, when an external sensor, such as the camera 19, which is likely to be affected by illuminance is used as the external sensor 112, the optimum time estimation unit 117 may preferentially estimate the optimum time to be a date and a time, such as a bright time slot in daytime or a sunny day, when high illuminance is likely to be obtained. However, when an external sensor, such as the ToF sensor 21 or the LIDAR sensor, which is unlikely to be affected by illuminance is used, the optimum time estimation unit 117 may preferentially estimate the optimum time to be nighttime at which the number of moving objects is presumed to be relatively small. As for illuminance, an illuminance sensor may be separately provided as the external sensor 112, and optimum time estimation and last-minute determination on permission of preliminary map production processing execution may be executed based on a value obtained by the illuminance sensor. Note that the camera 19 may be used in place of the illuminance sensor to detect illuminance.

The optimum time estimation unit 117 instructs the preliminary map production unit 118 (as well as the self-position estimation unit 115 when needed) to produce a preliminary map at the optimum time estimated as described above.

At the optimum time estimated by the optimum time estimation unit 117, the preliminary map production unit 118 moves the autonomous mobile object 1 to acquire external information related to a preliminary map production target region, and accordingly produces a preliminary map by using the acquired external information. Then, the preliminary map production unit 118 stores the produced preliminary map in the preliminary map database 103.

For example, the self-position estimation unit 104 acquires, from the preliminary map database 103, a preliminary map of surroundings of the autonomous mobile object 1 or a region to which the autonomous mobile object 1 belongs, and estimates the self-position of the autonomous mobile object 1 by the self-position estimation of the star-reckoning scheme by using the acquired preliminary map and external information input from the external sensor 112. Alternatively, the self-position estimation unit 104 estimates the self-position of the autonomous mobile object 1 by the self-position estimation of the dead-reckoning scheme by using internal information input from the internal sensor 113, acquires, from the preliminary map database 103, a preliminary map of surroundings of the autonomous mobile object 1 or a region to which the autonomous mobile object 1 belongs, executes the self-position estimation of the star-reckoning scheme by using the acquired preliminary map and external information input from the external sensor 112, and corrects, based on a self-position thus obtained, the self-position estimated by the self-position estimation of the dead-reckoning scheme.

Note that when the block configuration illustrated in FIG. 4 is achieved by the system configuration illustrated in FIG. 3, for example, the sensor group 111 the moving object detection unit 114, and the self-position estimation units 115 and 104 are incorporated in the autonomous mobile object 1, and the self-position estimation unit 115, the preliminary moving object information database 116, the optimum time estimation unit 117, the preliminary map production unit 118, and the preliminary map database 103 are incorporated in the server 2. In this case, each component incorporated in the autonomous mobile object 1 is achieved by, for example, the CPU 12 (refer to FIG. 1) reading and executing a control program stored in the memory card 30 or the flash ROM 14. However, components disposition is not limited to the above-described disposition but may be modified in various manners.

1.3 Self-Position Estimation Operation

Subsequently, self-position estimation operation according to the present embodiment will be described below in detail with reference to the accompanying drawings.

1.3.1 Schematic Process of Self-Position Estimation Operation

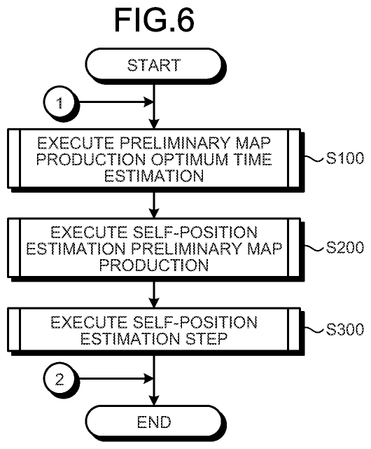

FIG. 6 is a flowchart illustrating a schematic process of the self-position estimation operation according to the present embodiment. As illustrated in FIG. 6, the self-position estimation operation according to the present embodiment mainly includes a preliminary map production optimum time estimation step (step S100) of estimating a time optimum for preliminary map production, a self-position estimation preliminary map production step (step S200) of producing a preliminary map at the estimated optimum time, and a self-position estimation step (step S300) of estimating a self-position by using the produced preliminary map.

1.3.2 Preliminary Map Production Optimum Time Estimation Step

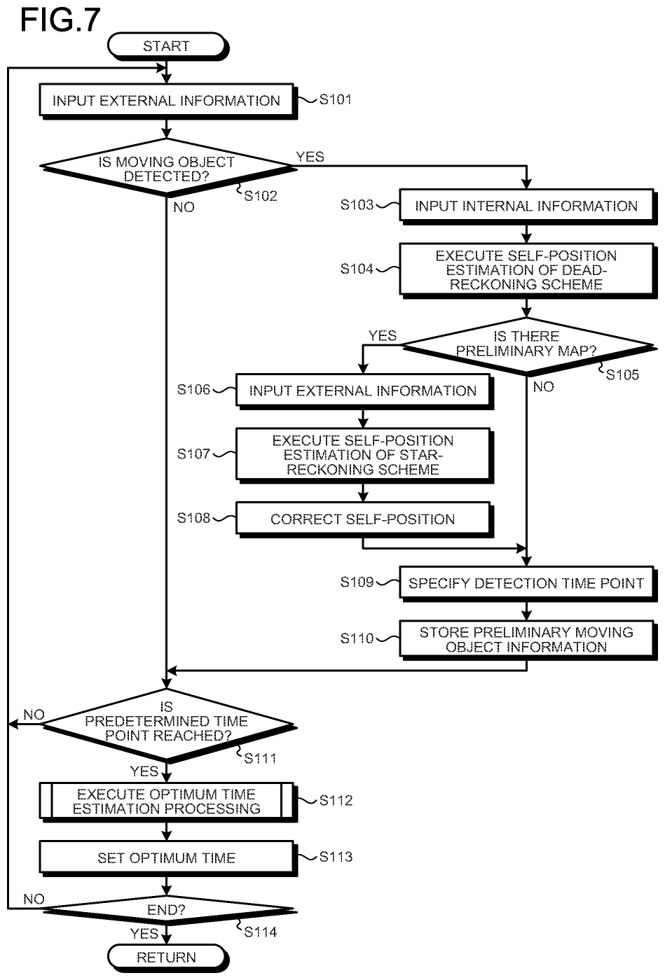

When the autonomous mobile object 1 is activated to start operating, the self-position estimation device (system) 100 including the autonomous mobile object 1 first starts the preliminary map production optimum time estimation step (step S100 in FIG. 6). FIG. 7 is a flowchart illustrating exemplary operation of the preliminary map production optimum time estimation step according to the present embodiment.

As illustrated in FIG. 7, first at the preliminary map production optimum time estimation step, external information acquired by the external sensor 112 of the autonomous mobile object 1 is input to the moving object detection unit 114 (step S101), and moving object detection is executed at the moving object detection unit 114 (step S102). For example, map matching or optical flow may be used in the moving object detection as described above. Information specified by the moving object detection includes, for example, at least one of the moving object kind ID and the individual ID.

When no moving object is detected (NO at step S102) as a result of the moving object detection at step S102, the present operation proceeds to step S111. When a moving object is detected (YES at step S102), internal information acquired by the internal sensor 113 is input to the self-position estimation unit 115 (step S103), and the self-position estimation of the dead-reckoning scheme is executed at the self-position estimation unit 115 (step S104). Accordingly, the self-position of the autonomous mobile object 1 is estimated.

Subsequently, for example, it is determined whether a preliminary map for a region to which the autonomous mobile object 1 currently belongs is already produced and already downloaded from the preliminary map database 103 (step S105). When the preliminary map is not already downloaded (NO at step S105), the present operation proceeds to step S109. When the preliminary map for the region is already downloaded (YES at step S105), the external information acquired by the external sensor 112 is input to the self-position estimation unit 115 (step S106), and the self-position estimation of the star-reckoning scheme is executed at the self-position estimation unit 115 (step S107).

Then, a self-position estimated through the self-position estimation of the dead-reckoning scheme at step S104 is corrected based on a self-position estimated through the self-position estimation of the star-reckoning scheme at step S107 (step S108), and the present operation proceeds to step S109. Note that the self-position obtained at step S104 or S108 is information for specifying a region (region ID) in which the moving object is detected at step S102, and is acquired as one piece of preliminary moving object information related to the moving object.

At step S109, for example, the current time is specified as a time point at which the moving object is detected at step S102 (step S109). The time point is information for specifying the time point (or time slot) at which the moving object is detected at step S102, and is acquired as one piece of preliminary moving object information related to the moving object.

Subsequently, the preliminary moving object information acquired as described above is stored in the preliminary moving object information database 116 (step S110). The preliminary moving object information database 116 may be disposed in the autonomous mobile object 1 or may be disposed in the server 2 (refer to FIG. 3) side connected with the autonomous mobile object 1 through the predetermined network.

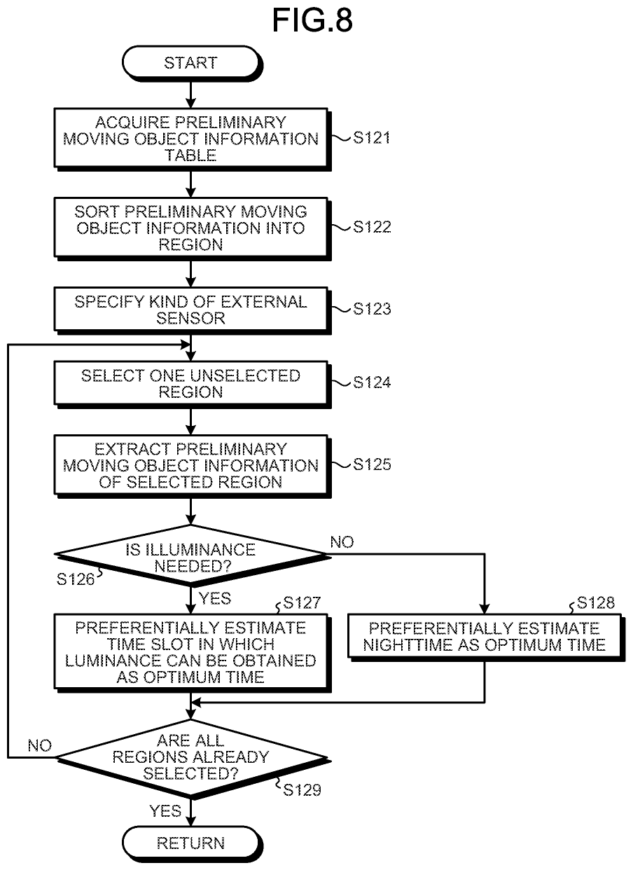

At step S111, it is determined whether a predetermined time point is reached. Note that the predetermined time point is a time point at which processing of estimating a time optimum for acquiring information used in preliminary map production is executed, and may be, for example, a time point after a predetermined time since activation of the autonomous mobile object 1. When the predetermined time point is not reached (NO at step S111), the present operation returns to step S101. When the predetermined time point is reached (YES at step S111), the optimum time estimation unit 117 executes optimum time estimation processing of estimating a time optimum for acquiring information used in preliminary map production (step S112). A detailed example of the optimum time estimation processing will be described later with reference to FIG. 8.

Thereafter, the optimum time estimated at step S112 is set (step S113), and then it is determined whether to end the present operation (step S114). When the present operation is not to be ended (NO at step S114), the present operation returns to step S101. When the present operation is to be ended (YES at step S114), the present operation is ended and returns to the operation illustrated in FIG. 6.

1.3.2.1 Optimum Time Estimation Processing

Exemplary optimum time estimation processing at step S112 in FIG. 7 will be described below in detail with reference to FIG. 8. As illustrated in FIG. 8, in the optimum time estimation processing according to the present embodiment, the optimum time estimation unit 117 acquires the preliminary moving object information table (refer to FIG. 5) from the preliminary moving object information database 116 (step S121). Subsequently, the optimum time estimation unit 117 sorts preliminary moving object information of each moving object registered in the acquired optimum time information table by regions in accordance with the region ID (step S122).

Subsequently, the optimum time estimation unit 117 specifies the kind of the external sensor 112 used by the autonomous mobile object 1 to acquire preliminary map production external information (step S123). For example, the optimum time estimation unit 117 specifies, based on a model code or the like of the autonomous mobile object 1, which is registered in advance, whether the external sensor 112 used to acquire preliminary map production external information is a sensor, such as the camera 19, which needs illuminance at information acquisition, or is a sensor, such as the ToF sensor 21 or the LIDAR sensor, which does not need illuminance.

Subsequently, the optimum time estimation unit 117 selects one unselected region from among region IDs having information registered in the preliminary moving object information table (step S124) and extracts, from the preliminary moving object information table, preliminary moving object information related to a moving object detected in the selected region (step S125).

Subsequently, the optimum time estimation unit 117 determines whether illuminance is needed at acquisition of preliminary map production external information based on the kind of the external sensor 112 specified at step S123 (step S126). When illuminance is needed (YES at step S126), the optimum time estimation unit 117 prioritizes a date and a time when high illuminance is likely to be obtained, such as a bright time slot in daytime, and estimates an optimum time based on the preliminary moving object information for the selected region (step S127). When illuminance is not needed (NO at step S126), the optimum time estimation unit 117 prioritizes nighttime at which the number of moving objects is presumed to be relatively small, and estimates an optimum time based on the preliminary moving object information for the selected region (step S128).

Note that, as described above in the optimum time estimation at step S127 or S128, for example, the number of moving objects existing in the target region is specified for each time slot, and a time slot in which the number of moving objects is smallest is estimated as an optimum time for the target region based on the number. The optimum time may be estimated by performing weighting in accordance with a moving object size specified based on the moving object kind ID, the individual ID, or the like.

Thereafter, the optimum time estimation unit 117 determines whether all the region IDs having information registered in the preliminary moving object information table are already selected (step S129). When the selection is completed (YES at step S129), the present operation is ended. When there is any unselected region (NO at step S129), the optimum time estimation unit 117 returns to step S124, selects one unselected region, and executes the same subsequent operation. Accordingly, the time optimum for acquiring information used in preliminary map production is estimated for each region ID having information registered in the preliminary moving object information table.

1.3.3 Self-Position Estimation Preliminary Map Production Step

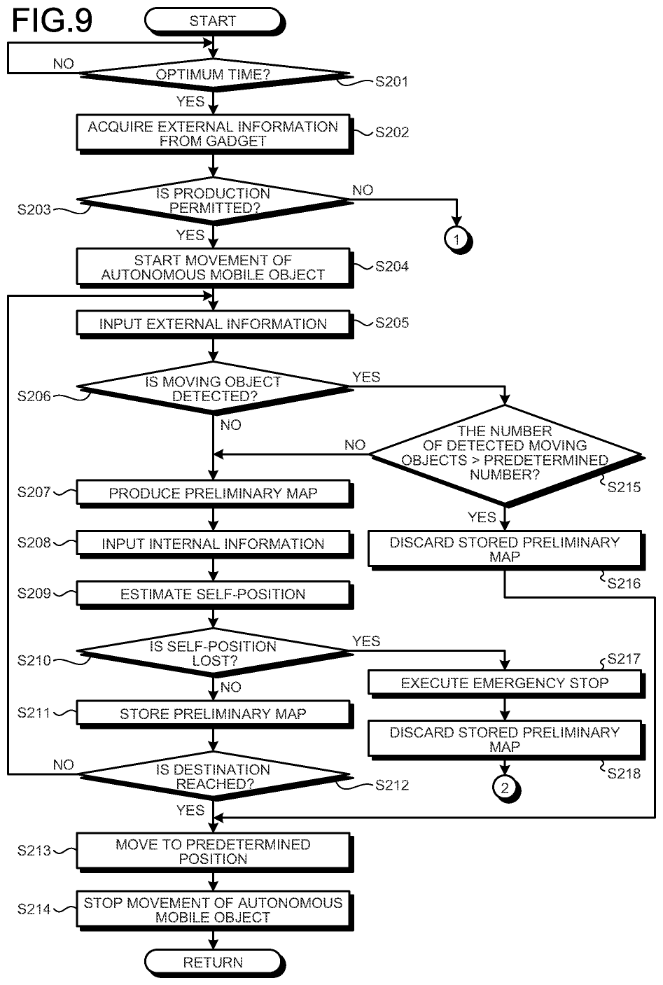

When the preliminary map production optimum time estimation step is completed, the self-position estimation preliminary map production step (step S200 in FIG. 6) is subsequently executed. FIG. 9 is a flowchart illustrating exemplary operation of the self-position estimation preliminary map production step according to the present embodiment. Note that although region distinction is not made in FIG. 9, the self-position estimation preliminary map production step illustrated in FIG. 9 may be executed for each region.

As illustrated in FIG. 9, first at the self-position estimation preliminary map production step, the optimum time estimation unit 117 determines whether the optimum time set at the preliminary map production optimum time estimation step is reached (step S201). When the optimum time is reached (YES at step S201), the optimum time estimation unit 117 acquires external information from the external sensor mounted on the gadget 105, such as the GPS sensor 105a, the IMU 105b, or the radio field intensity sensor 105c (step S202) and determines whether preliminary map production is permitted based on the external information (step S203). For example, when having specified that the owner exists in the target region based on the external information acquired from the external sensor of the gadget 105, the optimum time estimation unit 117 determines that preliminary map production is not permitted (NO at step S203). When having specified that the owner does not exist in the target region, the optimum time estimation unit 117 determines that preliminary map production is permitted (YES at step S203). Note that step S203 is not limited to the external information acquired from the external sensor of the gadget 105, but whether preliminary map production is permitted may be determined based on illuminance information acquired by the illuminance sensor or the camera 19.

When it is determined that preliminary map production is not permitted (NO at step S203), the present operation returns to, for example, step S100 in FIG. 6 and executes the preliminary map production optimum time estimation step again. When it is determined that preliminary map production is permitted (YES at step S203), the autonomous mobile object 1 is caused to start moving to a destination set in advance based on preliminary land shape information and information input from the user (step S204). Alternatively, the autonomous mobile object 1 is caused to start random movement. Then, while the autonomous mobile object 1 is moving, the external information acquired by the external sensor 112 of the autonomous mobile object 1 is sequentially input to the moving object detection unit 114 (step S205), and moving object detection is executed at the moving object detection unit 114 (step S206). For example, map matching or optical flow may be used in the moving object detection as described above. However, at step S206, for example, the number of moving objects included in the acquired external information and the ratio of moving object information in the external information are specified.

When no moving object is detected at step S206 (NO at step S206), the present operation proceeds to step S207. When any moving object is detected (YES at step S206), it is determined whether the number of detected moving objects is larger than a predetermined number set in advance (step S215). When the number of detected moving objects is larger than the predetermined number (YES at step S215), a preliminary map produced for the region and stored in the preliminary map database 103 is discarded (step S216), and the present operation proceeds to step S213. When the number of detected moving objects is equal to or smaller than the predetermined number (NO at step S215), the present operation proceeds to step S207.

At step S207, a local environmental map of surroundings of the autonomous mobile object 1 is produced as part of a preliminary map for the target region by using the external information input at step S205.

Subsequently, the internal information acquired by the internal sensor 113 of the autonomous mobile object 1 is input to the self-position estimation unit 115 (step S208), and the self-position estimation of the dead-reckoning scheme is executed at the self-position estimation unit 115 (step S209). Subsequently, whether the autonomous mobile object 1 has lost the self-position is determined based on a result of the self-position estimation (step S210). When the autonomous mobile object 1 has lost the self-position (YES at step S210), the autonomous mobile object 1 is emergently stopped (step S217), the preliminary map produced for the region and stored in the preliminary map database 103 is discarded (step S218), and thereafter, the present operation is ended (refer to FIG. 6). When the autonomous mobile object 1 has not lost the self-position (NO at step S210), the local environmental map produced at step S207 is subjected to map connection by map matching with the preliminary map stored in the preliminary map database 103 and then is stored in the preliminary map database 103 (step S211).

Subsequently, it is determined whether the autonomous mobile object 1 has reached the destination (step S212). When the autonomous mobile object 1 has not reached the destination (NO at step S212), the present operation returns to step S205 and continues preliminary map production. When the autonomous mobile object 1 has reached the destination (YES at step S212), the autonomous mobile object 1 is moved to a predetermined position, for example, a position at which the movement is started at step S204 (for example, the position of a charger for the autonomous mobile object 1) (step S213). Thereafter, the movement of the autonomous mobile object 1 is stopped (step S214), and then the present operation returns to the operation illustrated in FIG. 6.

1.3.4 Self-Position Estimation Step

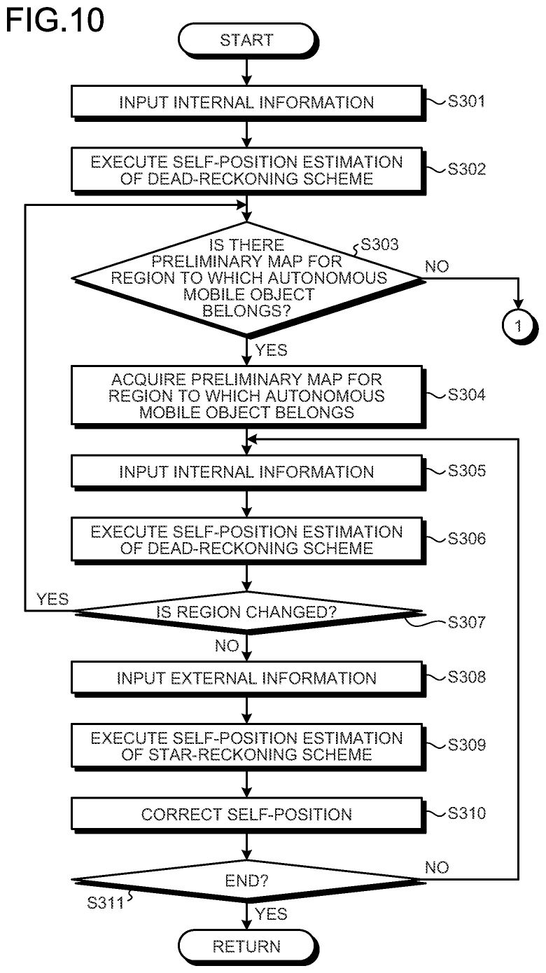

After the preliminary map is produced as described above, the self-position estimation step (step S300 in FIG. 6) is executed by using the produced preliminary map. FIG. 10 is a flowchart illustrating exemplary operation of the self-position estimation step according to the present embodiment.

As illustrated in FIG. 10, at the self-position estimation step, the internal information acquired by the internal sensor 113 of the autonomous mobile object 1 is input to the self-position estimation unit 104 (step S301). Note that the self-position estimation unit 104 may have a configuration identical to or separately independent from that of the self-position estimation unit 115 as described above. The self-position estimation unit 104 executes the self-position estimation of the dead-reckoning scheme by using the input internal information (step S302). Accordingly, the self-position of the autonomous mobile object 1 is estimated.

Subsequently, the self-position estimation unit 104 determines, based on the self-position of the autonomous mobile object 1 estimated at step S302, whether a preliminary map for a region to which the autonomous mobile object 1 currently belongs is stored in the preliminary map database 103 (step S303). When the preliminary map is not stored (NO at step S303), the self-position estimation unit 104 returns to step S100 in FIG. 6 to execute the preliminary map production optimum time estimation step and later again. When the preliminary map for the region is stored in the preliminary map database 103 (YES at step S303), the self-position estimation unit 104 acquires the preliminary map for the region from the preliminary map database 103 (step S304).

Subsequently, the self-position estimation unit 104 receives the internal information acquired by the internal sensor 113 of the autonomous mobile object 1 (step S305) and executes the self-position estimation of the dead-reckoning scheme by using the received internal information (step S306). Accordingly, the self-position of the autonomous mobile object 1 is estimated again.

Subsequently, the self-position estimation unit 104 determines whether the region to which the autonomous mobile object 1 belongs is changed based on the self-position of the autonomous mobile object 1 estimated at step S306 (step S307). When the region is changed (YES at step S307), the self-position estimation unit 104 returns to step S303 to execute the subsequent operation. When the region to which the autonomous mobile object 1 belongs is not changed (NO at step S307), the self-position estimation unit 104 receives the external information acquired by the external sensor 112 of the autonomous mobile object 1 (step S308) and executes the self-position estimation of the star-reckoning scheme by using the received external information and the preliminary map acquired at step S304 (step S309).

Then, the self-position estimation unit 104 corrects the self-position estimated through the self-position estimation of the dead-reckoning scheme at step S306 based on a self-position estimated through the self-position estimation of the star-reckoning scheme at step S309 (step S310).

Thereafter, the self-position estimation unit 104 determines whether to end the present operation (step S311). When the present operation is not to be ended (NO at step S311), the self-position estimation unit 104 returns to step S305 and executes the subsequent operation. When the present operation is to be ended (YES at step S311), the self-position estimation unit 104 ends the present operation.

1.4 Effects

As described above, according to the present embodiment, it is possible to produce a preliminary map with which the accuracy of self-position estimation can be improved since a time optimum for acquiring information used in preliminary map production is estimated and preliminary map production information is acquired at the estimated optimum time. As a result, it is possible to achieve an information processing device, an optimum time estimation method, a self-position estimation method, and a record medium recording a computer program, which are capable of improving the accuracy of self-position estimation.

In the present embodiment, a time slot in which the number of moving objects is small is estimated and a preliminary map is produced in the time slot, but in reality, moving objects are detected in some cases. For example, in such a case, the owner of the autonomous mobile object 1 comes home in a time slot different from a usual time slot, or for example, a pet moves in a time slot in which the pet usually does not move. To handle such a case, in the present embodiment, moving object detection (step S206 in FIG. 9) is executed during the self-position estimation preliminary map production step, and a preliminary map already produced and stored in the preliminary map database 103 is discarded (step S216 in FIG. 9) when a result of the detection satisfies a predetermined condition (YES at step S215 in FIG. 9). Accordingly, it is possible to prevent a preliminary map having a low information density from being stored in the preliminary map database 103.

In the present embodiment, the self-position of the autonomous mobile object 1 needs to be estimated also during the self-position estimation preliminary map production step (step S209 in FIG. 9), but a preliminary map is yet to be produced at this stage in some cases. In such a case, the self-position estimation of the star-reckoning scheme cannot be performed, and the self-position of the autonomous mobile object 1 is estimated only through the self-position estimation of the dead-reckoning scheme. However, only with the self-position estimation of the dead-reckoning scheme, the autonomous mobile object 1 potentially loses the self-position due to accumulated error generation. A preliminary map produced in the state in which the autonomous mobile object 1 has lost the self-position is potentially an inaccurate map, and thus in the present embodiment, the autonomous mobile object 1 is emergently stopped (step S217 in FIG. 9) when the autonomous mobile object 1 has lost the self-position (YES at step S210 in FIG. 9), and a preliminary map already produced and stored in the preliminary map database 103 is discarded (step S218 in FIG. 9). Accordingly, it is possible to prevent an inaccurate preliminary map from being stored in the preliminary map database 103.

1.5 Modification

Note that the self-position estimation preliminary map production step (step S200 in FIG. 6) is not limited to once per activation of the autonomous mobile object 1 but may be periodically (for example, daily) repeated. In this case, preliminary moving object information related to a large number of moving objects can be accumulated in the preliminary moving object information database 116 by periodically (for example, daily) repeating the preliminary map production optimum time estimation step (step S100 in FIG. 6) as well. Thus, a time optimum for acquiring information used in preliminary map production can be estimated and a preliminary map can be produced at the optimum time. Accordingly, it is possible to further reduce decrease of the information density of the preliminary map, thereby achieving self-position estimation at higher accuracy.

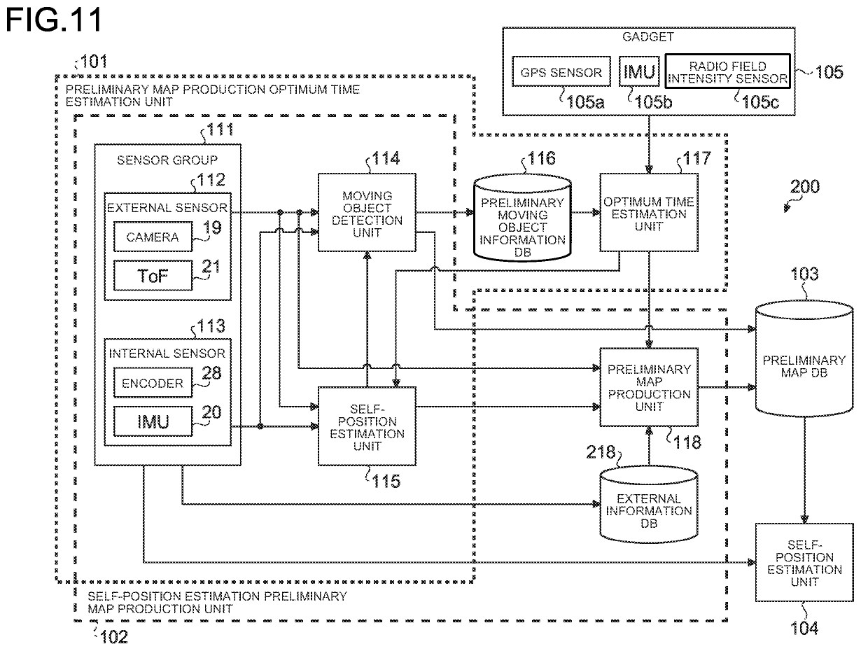

The embodiment describes above the example (refer to FIG. 9) in which the acquisition of, by the external sensor 112, external information to be used in preliminary map production at an optimum time estimated by the optimum time estimation unit 117 and the production of a preliminary map by using the external information acquired by the external sensor 112 at the optimum time are executed as a series of process, but is not limited to such a configuration and operation. For example, as illustrated in FIG. 11, an external information database (external information storage unit) 218 configured to store external information acquired by the external sensor 112 at the optimum time estimated by the optimum time estimation unit 117 may be provided so that the preliminary map production unit 118 produces a preliminary map by using the external information accumulated in the external information database 218 at an optional or predetermined time. Note that the other configuration and operation of a self-position estimation device (system) 200 illustrated in FIG. 11 may be same as those of the self-position estimation device (system) 100 illustrated in FIG. 4, and thus detailed description thereof is omitted.

Although the embodiment of the present disclosure is described above, the technical scope of the present disclosure is not limited to the above-described embodiment as it is, but may include various kinds of modifications without departing from the gist of the present disclosure. Components of the embodiment and the modification, respectively, may combined as appropriate.

The effects of the embodiment disclosed in the present specification are merely exemplary, but not limited and may include other effects.

Note that the present technique may be configured as follows.
(1)

An information processing device comprising a determination unit configured to determine an acquisition time at which preliminary map production information for producing a preliminary map used by a mobile object to estimate a self-position is to be acquired based on time information related to a time at which a moving object exists in a predetermined region, the time information being based on external information of the predetermined region detected by an external sensor.
(2)

The information processing device according to (1), wherein the determination unit determines the acquisition time based on a ratio of moving object information in the external information acquired by using the external sensor.
(3)

The information processing device according to (1), wherein the determination unit determines the acquisition time based on number of moving objects existing in the predetermined region.
(4)

The information processing device according to (1), further comprising a moving object information storage unit configured to store the time information, wherein

the determination unit determines the acquisition time based on the time information stored in the moving object information storage unit.
(5)

The information processing device according to (1), further comprising a detection unit configured to detect a moving object existing in surroundings of the external sensor by using the external information acquired by the external sensor, wherein

the determination unit determines the acquisition time based on time information specified when the moving object is detected by the detection unit.
(6)

The information processing device according to (5), further comprising a generation unit configured to generate a kind ID for specifying the kind of the moving object based on the external information acquired by the external sensor, wherein

the determination unit determines the acquisition time by performing weighting for each time slot based on the time information and the kind ID.
(7)

The information processing device according to (6), further comprising a moving object information storage unit configured to associate and store the time information and the kind ID related to an identical moving object, wherein the determination unit determines the acquisition time based on the time information and the kind ID stored in the moving object information storage unit.
(8)

The information processing device according to (1), further comprising a production unit configured to produce a preliminary map by using the external information acquired by the external sensor at the acquisition time determined by the determination unit as the preliminary map production information.
(9)

The information processing device according to (8), wherein in a process of producing a preliminary map by using the preliminary map production information acquired at the acquisition time determined by the determination unit, the production unit determines, based on number of moving objects detected based on the external information acquired by the external sensor, whether to discard a preliminary map produced based on the preliminary map production information acquired at the acquisition time.
(10)

The information processing device according to (8), further comprising a generation unit configured to identify, as an individual, the moving object existing in surroundings of the external sensor and generate an individual ID for specifying the identified individual of the moving object, wherein

the determination unit associates, based on the time information and the individual ID related to an identical moving object, with the individual ID, whether a gadget including an external sensor related to the individual specified by the individual ID is registered and gadget information for specifying the gadget when the gadget is registered, and determines the acquisition time, and

when producing the preliminary map by using the preliminary map production information acquired at the acquisition time, the production unit determines whether production of the preliminary map is permitted based on the gadget information.
(11)

The information processing device according to (8), further comprising a first estimation unit configured to estimate a first self-position of the mobile object by using the preliminary map produced by the production unit and the external information acquired by the external sensor.
(12)

The information processing device according to (11), further comprising:

an internal sensor configured to acquire at least one internal information among a movement distance, movement speed, movement direction, and posture of the mobile object;

a second estimation unit configured to estimate a second self-position of the mobile object by using the internal information acquired by the internal sensor; and

a generation unit configured to generate a region ID for specifying a region including the second self-position estimated by the second estimation unit when the moving object is detected, wherein

the determination unit determines the acquisition time for each region based on the time information and the region ID.
(13)

The information processing device according to (12), wherein in a process of producing a preliminary map by using the preliminary map production information acquired at the acquisition time determined by the determination unit, the production unit discards the preliminary map produced based on the preliminary map production information acquired at the acquisition time when the second estimation unit has lost the self-position of the mobile object.
(14)

The information processing device according to (11), further comprising an internal sensor configured to acquire at least one internal information among a movement distance, movement speed, movement direction, and posture of the mobile object, wherein

the first estimation unit estimates a second self-position of the mobile object by using the internal information acquired by the internal sensor and corrects the second self-position with the first self-position.
(15)

The information processing device according to (11), further comprising a map storage unit configured to store the preliminary map produced by the production unit, wherein

the first estimation unit acquires, from the map storage unit, the preliminary map produced by the production unit and estimates the first self-position of the mobile object by using the acquired preliminary map and information acquired by the external sensor.
(16)

The information processing device according to (1), wherein the external sensor includes at least one of a camera, a time-of-flight (ToF) sensor, a light detection-and-ranging or laser-imaging-detection-and-ranging (LIDAR) sensor, a global positioning system (GPS) sensor, a magnetic sensor, and a radio field intensity sensor.
(17)

The information processing device according to (12), wherein the internal sensor includes at least one of an inertial measurement unit, an encoder, a potentiometer, an acceleration sensor, and an angular velocity sensor.
(18)

An optimum time estimation method comprising determining an acquisition time at which preliminary map production information for producing a preliminary map used by a mobile object to estimate a self-position is to be acquired based on time information related to a time at which a moving object exists in a predetermined region, the time information being based on external information of the predetermined region detected by an external sensor.
(19)

A self-position estimation method comprising:

determining an acquisition time at which preliminary map production information for producing a preliminary map used by a mobile object to estimate a self-position is to be acquired based on time information related to a time at which a moving object exists in a predetermined region, the time information being based on external information of the predetermined region detected by an external sensor;

producing a preliminary map at the determined acquisition time by using the external information acquired by the external sensor; and

estimating the self-position of the mobile object by using the produced preliminary map and the external information acquired by the external sensor.
(20)

A record medium recording a computer program for causing a computer to determine an acquisition time at which preliminary map production information for producing a preliminary map used by a mobile object to estimate a self-position is to be acquired based on time information related to a time at which a moving object exists in a predetermined region, the time information being based on external information of the predetermined region detected by an external sensor.
(21)

The information processing device according to (2), in which the determination unit determines, based on the time information, the acquisition time to be a time at which the ratio of moving object information in the external information acquired by using the external sensor is smallest.
(22)

The information processing device according to (4), in which the determination unit determines, based on the time information, the acquisition time to be a time at which the number of moving objects existing in the predetermined region is estimated to be smallest.
(23)

The information processing device according to (12), in which, when the number of moving objects existing in the predetermined region exceeds a predetermined number, the production unit discards the preliminary map produced based on the preliminary map production information acquired at the acquisition time.
(24)

The information processing device according to (10), in which the production unit specifies the current position of the gadget based on the gadget information and does not permit production of the preliminary map when the gadget exists in the predetermined region.
(25)

An information processing system including a determination unit configured to determine an acquisition time at which preliminary map production information for producing a preliminary map used by a mobile object to estimate a self-position is to be acquired based on time information related to a time at which a moving object exists in a predetermined region, the time information being based on external information of the predetermined region detected by an external sensor. Reference Signs List

1 autonomous mobile object

10 control unit

11 signal processing circuit

12 CPU

13 DRAM

14 flash ROM

15 PC card interface

16 wireless communication unit

17 internal bus

18 battery

19 CCD camera

20 IMU

21 ToF sensor

22 touch sensor

23 microphone

24 speaker

25 display unit

26 movable unit

27 actuator

28 encoder (potentiometer)

29 memory card

100, 200 self-position estimation device (system)

101 preliminary map production optimum time estimation unit

102 self-position estimation preliminary map production unit

103 preliminary map database

104 self-position estimation unit

105 gadget

105a GPS sensor

105b IMU

105c radio field intensity sensor

111 sensor group

112 external sensor

113 internal sensor

114 moving object detection unit

115 self-position estimation unit

116 preliminary moving object information database

117 optimum time estimation unit

118 preliminary map production unit

218 external information database

1. An information processing device comprising a determination unit configured to determine an acquisition time at which preliminary map production information for producing a preliminary map used by a mobile object to estimate a self-position is to be acquired based on time information related to a time at which a moving object exists in a predetermined region, the time information being based on external information of the predetermined region detected by an external sensor.

2. The information processing device according to claim 1, wherein the determination unit determines the acquisition time based on a ratio of moving object information in the external information acquired by using the external sensor.

3. The information processing device according to claim 1, wherein the determination unit determines the acquisition time based on number of moving objects existing in the predetermined region.

4. The information processing device according to claim 1, further comprising a moving object information storage unit configured to store the time information, wherein
the determination unit determines the acquisition time based on the time information stored in the moving object information storage unit.

5. The information processing device according to claim 1, further comprising a detection unit configured to detect a moving object existing in surroundings of the external sensor by using the external information acquired by the external sensor, wherein
the determination unit determines the acquisition time based on time information specified when the moving object is detected by the detection unit.

6. The information processing device according to claim 5, further comprising a generation unit configured to generate a kind ID for specifying the kind of the moving object based on the external information acquired by the external sensor, wherein
the determination unit determines the acquisition time by performing weighting for each time slot based on the time information and the kind ID.

7. The information processing device according to claim 6, further comprising a moving object information storage unit configured to associate and store the time information and the kind ID related to an identical moving object, wherein
the determination unit determines the acquisition time based on the time information and the kind ID stored in the moving object information storage unit.

8. The information processing device according to claim 1, further comprising a production unit configured to produce a preliminary map by using the external information acquired by the external sensor at the acquisition time determined by the determination unit as the preliminary map production information.

9. The information processing device according to claim 8, wherein in a process of producing a preliminary map by using the preliminary map production information acquired at the acquisition time determined by the determination unit, the production unit determines, based on number of moving objects detected based on the external information acquired by the external sensor, whether to discard a preliminary map produced based on the preliminary map production information acquired at the acquisition time.

10. The information processing device according to claim 8, further comprising a generation unit configured to identify, as an individual, the moving object existing in surroundings of the external sensor and generate an individual ID for specifying the identified individual of the moving object, wherein
the determination unit associates, based on the time information and the individual ID related to an identical moving object, with the individual ID, whether a gadget including an external sensor related to the individual specified by the individual ID is registered and gadget information for specifying the gadget when the gadget is registered, and determines the acquisition time, and
when producing the preliminary map by using the preliminary map production information acquired at the acquisition time, the production unit determines whether production of the preliminary map is permitted based on the gadget information.

11. The information processing device according to claim 8, further comprising a first estimation unit configured to estimate a first self-position of the mobile object by using the preliminary map produced by the production unit and the external information acquired by the external sensor.

12. The information processing device according to claim 11, further comprising:
an internal sensor configured to acquire at least one internal information among a movement distance, movement speed, movement direction, and posture of the mobile object;
a second estimation unit configured to estimate a second self-position of the mobile object by using the internal information acquired by the internal sensor; and
a generation unit configured to generate a region ID for specifying a region including the second self-position estimated by the second estimation unit when the moving object is detected, wherein
the determination unit determines the acquisition time for each region based on the time information and the region ID.

13. The information processing device according to claim 12, wherein in a process of producing a preliminary map by using the preliminary map production information acquired at the acquisition time determined by the determination unit, the production unit discards the preliminary map produced based on the preliminary map production information acquired at the acquisition time when the second estimation unit has lost the self-position of the mobile object.

14. The information processing device according to claim 11, further comprising an internal sensor configured to acquire at least one internal information among a movement distance, movement speed, movement direction, and posture of the mobile object, wherein
the first estimation unit estimates a second self-position of the mobile object by using the internal information acquired by the internal sensor and corrects the second self-position with the first self-position.

15. The information processing device according to claim 11, further comprising a map storage unit configured to store the preliminary map produced by the production unit, wherein
the first estimation unit acquires, from the map storage unit, the preliminary map produced by the production unit and estimates the first self-position of the mobile object by using the acquired preliminary map and information acquired by the external sensor.

16. The information processing device according to claim 1, wherein the external sensor includes at least one of a camera, a time-of-flight (ToF) sensor, a light detection-and-ranging or laser-imaging-detection-and-ranging (LIDAR) sensor, a global positioning system (GPS) sensor, a magnetic sensor, and a radio field intensity sensor.

17. The information processing device according to claim 12, wherein the internal sensor includes at least one of an inertial measurement unit, an encoder, a potentiometer, an acceleration sensor, and an angular velocity sensor.

18. An optimum time estimation method comprising determining an acquisition time at which preliminary map production information for producing a preliminary map used by a mobile object to estimate a self-position is to be acquired based on time information related to a time at which a moving object exists in a predetermined region, the time information being based on external information of the predetermined region detected by an external sensor.

19. A self-position estimation method comprising:
determining an acquisition time at which preliminary map production information for producing a preliminary map used by a mobile object to estimate a self-position is to be acquired based on time information related to a time at which a moving object exists in a predetermined region, the time information being based on external information of the predetermined region detected by an external sensor;
producing a preliminary map at the determined acquisition time by using the external information acquired by the external sensor; and
estimating the self-position of the mobile object by using the produced preliminary map and the external information acquired by the external sensor.

20. A record medium recording a computer program for causing a computer to determine an acquisition time at which preliminary map production information for producing a preliminary map used by a mobile object to estimate a self-position is to be acquired based on time information related to a time at which a moving object exists in a predetermined region, the time information being based on external information of the predetermined region detected by an external sensor.
